(19) United States
(12) Patent Application Publication
(10) Pub. No.: US 2026/0268468 A1
(43) Pub. Date: Sep. 10, 2026

(54) PHASE DISTRIBUTION MEASUREMENT METHOD AND OPTICAL MICROSCOPE DEVICE

(71) Applicant: Evident Corporation, Tatsuno-machi (JP)

(72) Inventor: Shinichi HAYASHI, Kamiina-gun (JP)

(73) Assignee: Evident Corporation, Tatsuno-machi (JP)

(21) Appl. No.: 19/551,319

(22) Filed: Feb. 26, 2026

(30) Foreign Application Priority Data
Mar. 6, 2025 (JP) 2025-035057

(51) Int. Cl. G06T 7/00; G02B 21/36

(52) U.S. Cl. CPC G06T 7/0002; G02B 21/361; G02B 21/365; G06T 2207/10012; G06T 2207/10056; G06T 2207/30024

(57) ABSTRACT

A phase distribution measurement method includes acquiring a gradient contrast image, calculating a phase gradient distribution of a sample based on the gradient contrast image, and calculating a phase distribution of the sample based on the phase gradient distribution. The gradient contrast image is a digital image of a sample generated based on an intensity of light beams detected by a light detection element via a first gradation filter disposed at a pupil of an objective in an optical microscope or at a position optically conjugate with the pupil. The first gradation filter has an optical density gradient that monotonically increases or monotonically decreases in a predetermined direction and that is constant in a direction orthogonal to the predetermined direction.

### CROSS-REFERENCE TO RELATED APPLICATION

This application is based upon and claims the benefit of priority from prior Japanese Patent Application No. 2025-035057, filed Mar. 6, 2025, the entire contents of which are incorporated herein by this reference.

### FIELD

The disclosure of the present specification relates to a phase distribution measurement method and an optical microscope device.

### BACKGROUND

In the related art, a technique for measuring a phase distribution of a colorless and transparent phase material using a differential interference contrast microscope is known. Such a technique is described, for example, in JP 2001-159736 A, US 2008/007824 A, and the like.

### SUMMARY

According to an aspect of the present invention, there is provided a phase distribution measurement method including: acquiring a gradient contrast image that is a digital image of a sample generated based on an intensity of light beams detected by a light detection element via a first gradation filter disposed at a pupil of an objective in an optical microscope or at a position optically conjugate with the pupil; calculating a phase gradient distribution of the sample based on the gradient contrast image; and calculating a phase distribution of the sample based on the phase gradient distribution, in which the first gradation filter has an optical density gradient that monotonically increases or monotonically decreases in a predetermined direction and remains constant in a direction orthogonal to the predetermined direction.

According to another aspect of the present invention, there is provided an optical microscope device including: an optical microscope including an objective and a first gradation filter disposed at a pupil of the objective or at a position optically conjugate with the pupil, the first gradation filter having an optical density gradient that monotonously increases or monotonously decreases in a predetermined direction and remains constant in a direction orthogonal to the predetermined direction; a light detection element that is configured to detect light beams passing through the objective and the first gradation filter; and a processor that is configured to execute: processing of acquiring a gradient contrast image which is a digital image of a sample generated based on an intensity of light beams detected by the light detection element; processing of calculating a phase gradient distribution of the sample based on the acquired gradient contrast image; and processing of calculating a phase distribution of the sample based on the phase gradient distribution.

### BRIEF DESCRIPTION OF THE DRAWINGS

FIG. 1 is a diagram illustrating a configuration of an optical microscope device according to a first embodiment and axial light beams in a case where a sample having a flat phase distribution is placed;

FIG. 2 is a diagram illustrating a configuration of the optical microscope device according to the first embodiment and axial light beams in a case where a sample having a phase distribution inclined in a certain direction is placed;

FIG. 3 is a diagram illustrating a configuration of the optical microscope device according to the first embodiment and axial light beams in a case where a sample having a phase distribution inclined in the opposite direction is placed;

FIG. 4 is a diagram illustrating a relationship between a position of an image of a pupil of a condenser lens projected onto a pupil of an objective and a transmitted light intensity distribution at the pupil of the objective;

FIG. 5 is a graph illustrating a relationship between a movement distance of an image of a pupil of a condenser lens and an image intensity;

FIG. 6 is a flowchart of phase distribution measurement processing performed by a control device according to the first embodiment;

FIG. 7 is a diagram illustrating a relationship between a position of an image of the pupil of the condenser lens and a transmitted light intensity distribution at the pupil of the objective in a case where an aperture stop is narrowed;

FIG. 8 is a graph illustrating a relationship between a movement distance of an image of the pupil of the condenser lens and an image intensity in a case where the aperture stop is narrowed;

FIG. 9 is a flowchart of processing performed by the optical microscope device according to the first embodiment;

FIG. 10 is a diagram for explaining a center coordinate of an image of the pupil of the condenser lens on a pupil plane of the objective;

FIG. 11 is a diagram illustrating a direction cosine of a diffraction wavefront on a sample surface;

FIG. 12 is a graph illustrating a relationship between a movement distance of an image of the pupil of the condenser lens and a ratio of image intensities of images acquired using gradation filters having different optical density gradients;

FIG. 13 is a diagram illustrating a configuration of an optical microscope device according to a second embodiment;

FIG. 14 is a flowchart of processing performed by the optical microscope device according to the second embodiment;

FIG. 15 is a diagram illustrating a relationship among a direction of an optical density gradient of a gradation filter, a position of an image of a pupil of a condenser lens, and a transmitted light intensity distribution in a pupil of an objective;

FIG. 16 is a graph illustrating a relationship between a movement distance of an image of a pupil of a condenser lens and a ratio of image intensities acquired using gradation filters in which directions of optical density gradients are different;

FIG. 17 is a flowchart of processing performed by the optical microscope device according to a third embodiment;

FIG. 18 is a diagram illustrating a relationship among a direction of an optical density gradient of a gradation filter, a position of an image of a pupil of a condenser lens, and a transmitted light intensity distribution in a pupil of an objective;

FIG. 19 is a diagram illustrating a configuration of an optical microscope device according to a fourth embodiment;

FIG. 20 is a diagram illustrating a configuration of an optical microscope device according to a fifth embodiment; and

FIG. 21 is a diagram illustrating a configuration of an optical microscope device according to a sixth embodiment.

### DETAILED DESCRIPTION

In the above-described technique using a differential interference contrast microscope, a phase distribution is measured using polarized light. For this reason, in a case where a birefringent material that disturbs a vibration plane of polarized light exists on an optical path, it is difficult to accurately measure a phase distribution of a measurement target. Therefore, for example, it is difficult to measure a phase distribution of living cells while the living cells are accommodated in a plastic petri dish which is a birefringent material.

Hereinafter, embodiments will be described with reference to the drawings.

### First Embodiment

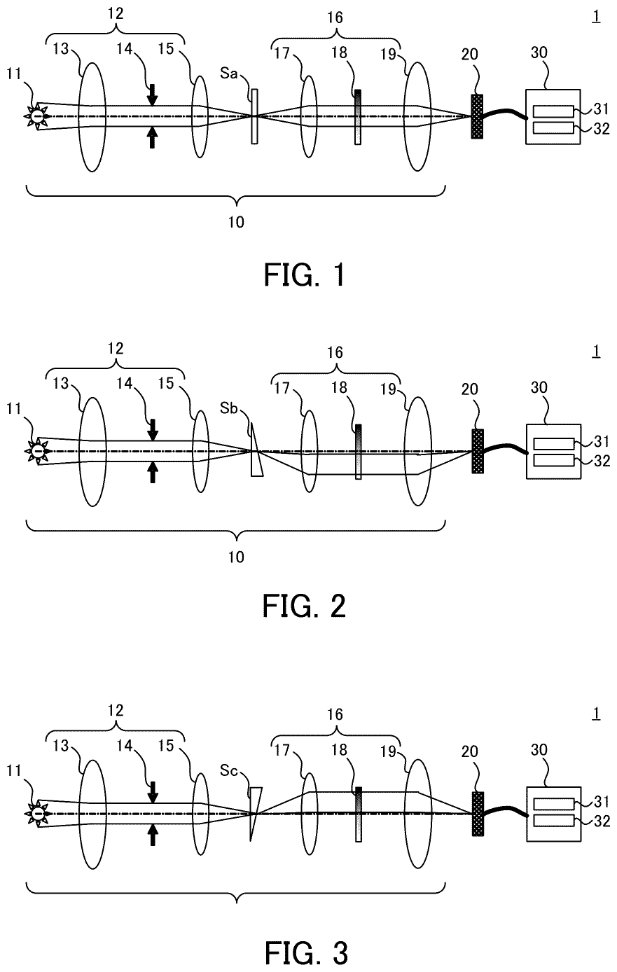

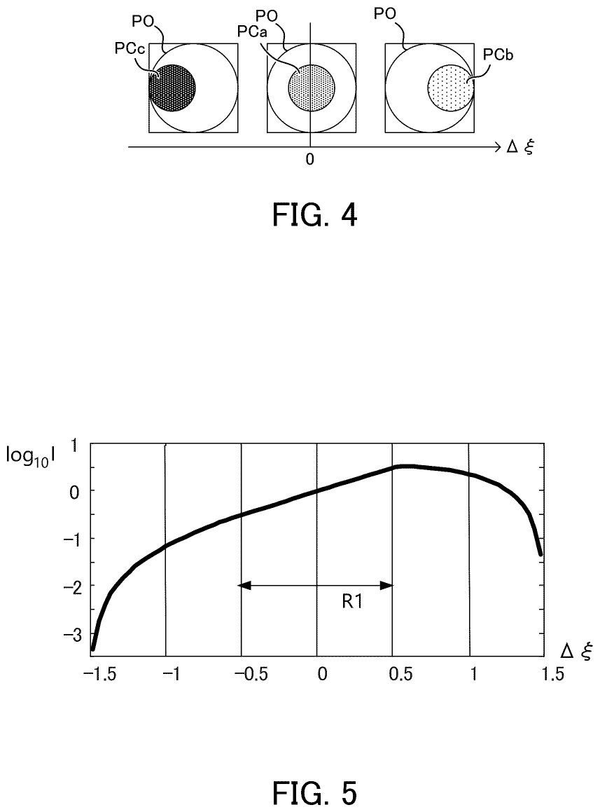

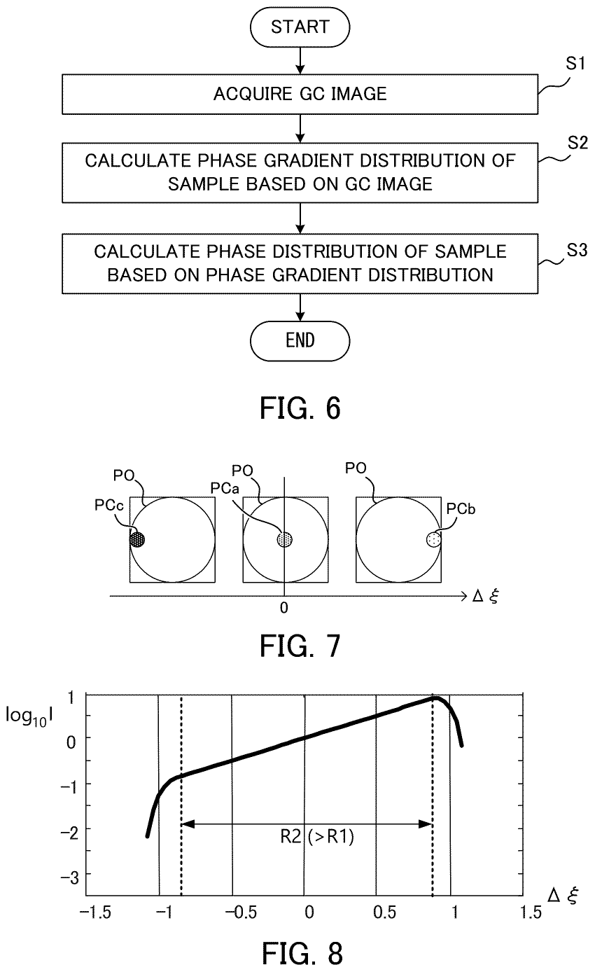

FIG. 1 to FIG. 3 are diagrams illustrating a configuration of an optical microscope device according to the present embodiment and axial light beams. FIG. 4 is a diagram illustrating a relationship between a position of an image of a pupil of a condenser lens projected onto a pupil of an objective and a transmitted light intensity distribution at the pupil of the objective. FIG. 5 is a graph illustrating a relationship between a movement distance of an image of a pupil of a condenser lens and an image intensity. FIG. 6 is a flowchart of phase distribution measurement processing performed by a control device according to the present embodiment. Hereinafter, a configuration of the optical microscope device 1 and a phase distribution measurement method of a sample will be described with reference to FIG. 1 to FIG. 6.

An optical microscope device 1 illustrated in FIG. 1 to FIG. 3 is a phase distribution measurement device that measures a phase distribution of a sample, and is a device that obtains an image (hereinafter, referred to as a gradient contrast image (GC image)) similar to an image obtained by a differential interference contrast microscope. The gradient contrast image is a type of a phase gradient image having an image intensity in which a phase gradient of the sample is reflected. More specifically, the gradient contrast image is an image having contrast of brightness and darkness that is created by modulating a light beam refracted according to the phase gradient of the sample with a gradation filter arranged at a pupil of an objective 17 or a position optically conjugate with the pupil, and is an image in which the phase distribution is stereoscopically visualized by the contrast of brightness and darkness.

Note that, in the present embodiment, in a state where it is assumed that a sample can have a phase gradient only in one direction, and FIG. 1, FIG. 2, and FIG. 3 respectively illustrate light beams when a sample Sa having a flat phase distribution, a sample Sb having a phase distribution inclined in a certain direction, and a sample Sc having a phase distribution inclined in an opposite direction of the direction are arranged. Hereinafter, when the sample Sa, the sample Sb, and the sample Sc are not particularly distinguished, the samples are referred to as a sample S. Note that, in the present specification, a sample refers to an observation target in a sample container arranged on a stage of the optical microscope device 1 in a narrow sense, and refers to the entire visual field on the stage of the optical microscope device 1 in a broad sense. Unless otherwise specified, the term may have either a narrow or broad meaning.

The optical microscope device 1 includes an optical microscope 10, an imaging element 20, and a control device 30. The optical microscope 10 is a microscope that includes an objective 17 and a gradation filter 18 and forms an optical image of the sample S on the imaging element 20. The optical microscope 10 includes a light source 11, and an illumination optical system 12 including a collector lens 13, an aperture stop 14, and a condenser lens 15 on an illumination optical path between the light source 11 and the sample S. The light source 11 is, for example, a halogen lamp. The optical microscope 10 further includes a detection optical system 16 including an objective 17, a gradation filter 18, and an imaging lens 19 on a detection optical path between the sample S and the imaging element 20. The objective 17 is an infinity-corrected microscope objective. The gradation filter 18 is a neutral density (ND) filter that attenuates light beams incident on the gradation filter 18, and is arranged in a pupil of the objective 17. The gradation filter 18 has an optical density gradient one-dimensionally along a predetermined direction. That is, the gradation filter 18 has an optical density that continuously changes along a predetermined direction. More specifically, the gradation filter 18 has an optical density gradient that monotonically increases or monotonically decreases in a predetermined direction, and that does not change in a direction orthogonal to the predetermined direction. The imaging element 20 is, for example, a charge-coupled device (CCD) image sensor, a complementary metal-oxide-semiconductor (CMOS) image sensor, or the like, and is disposed at an image position of the detection optical system 16. In the imaging element 20, photodiodes are two-dimensionally arranged. The photodiode is a light detection element that detects a light beam passing through the objective 17 and the gradation filter 18. The imaging element 20 generates a digital image (gradient contrast image) of the sample based on the intensity of light beams detected by the light detection element. The control device 30 is a computer including a processor 31 and a memory 32, and controls the entire operation of the optical microscope device 1.

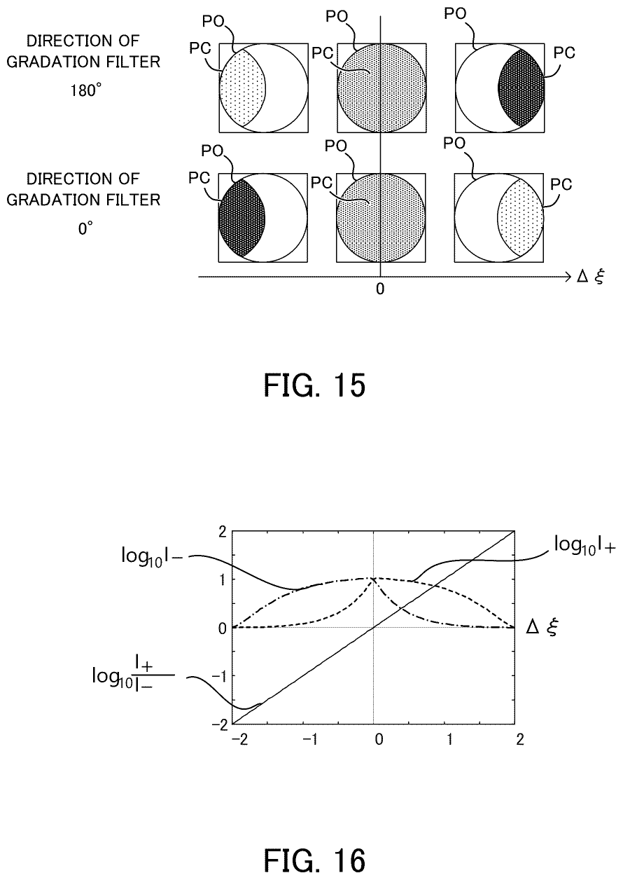

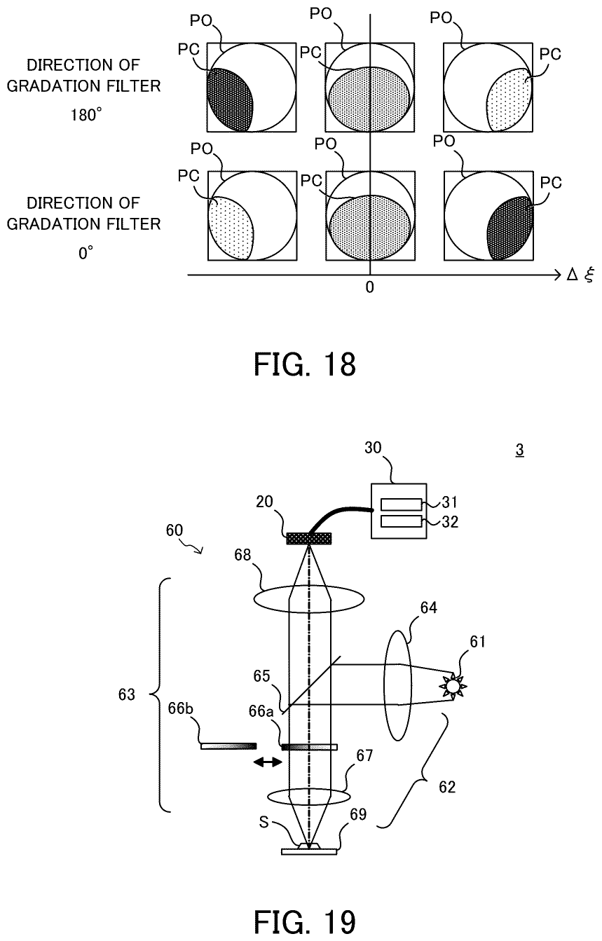

In the optical microscope device 1, as illustrated in FIG. 1 to FIG. 3, the light beams with which the sample S is irradiated are refracted according to the gradient (phase gradient) of the phase distribution of the sample S, and pass through different regions of the gradation filter 18 arranged in the pupil of the objective. More specifically, as the phase gradient is larger, the light beams are greatly refracted by the sample S, and an image of the pupil of the condenser lens 15 (the image of the aperture stop 14) is projected at a position away from the center of the pupil (the gradation filter 18) of the objective 17. For example, in a case where the phase distribution of the sample Sa is flat as illustrated in FIG. 1, an image PCa of the pupil of the condenser lens 15 is projected at the center of the pupil PO of the objective 17 as illustrated in FIG. 4. In this case, a distance Δξ between the center of the pupil PO of the objective 17 and the center of the image PCa of the pupil of the condenser lens 15 is 0. The distance Δξ is also referred to as a pupil movement distance of the condenser lens 15. As a result, the light beams from the sample Sa pass through a region near the optical axis of the gradation filter 18 placed in the pupil PO of the objective 17, and are attenuated with a medium intensity by the gradation filter 18. Therefore, the light beams passing through the gradation filter 18 and having a medium intensity enter the imaging element 20, and an image having a medium image intensity is generated. On the other hand, for example, in a case where there is a gradient in the phase distributions of the samples Sb and Sc as illustrated in FIG. 2 and FIG. 3, the images PCb and PCc of the pupil of the condenser lens 15 are projected at positions deviated from the center of the pupil of the objective 17 as illustrated in FIG. 4. More specifically, when the gradients of the phase distributions of the samples Sb and Sc are opposite, in a case where the image PCb of the pupil of the condenser lens 15 is projected at a position deviated from the center of the pupil of the objective 17 in a positive direction, the image PCc of the pupil of the condenser lens 15 is projected at a position deviated from the center of the pupil of the objective 17 in a negative direction. That is, a distance Δξ between the center of the pupil PO of the objective 17 and the center of the image PCb of the pupil of the condenser lens 15 is positive, and a distance Δξ between the center of the pupil PO of the objective 17 and the center of the image PCc of the pupil of the condenser lens 15 is negative. As a result, the light beams from the sample Sb pass through the region on the plus side with respect to the optical axis of the gradation filter 18 placed in the pupil PO of the objective 17, and are relatively weakly attenuated by the gradation filter 18. Therefore, relatively strong light beams passing through the gradation filter 18 enter the imaging element 20, and an image having a strong image intensity is generated. On the other hand, the light beams from the sample Sc pass through the region on the negative side with respect to the gradation filter 18 placed in the pupil PO of the objective 17, and are relatively strongly attenuated by the gradation filter 18. Therefore, relatively weak light beams passing through the gradation filter 18 enter the imaging element 20, and an image having a weak image intensity is generated. FIG. 5 illustrates such a relationship between the pupil movement distance Δξ and the image intensity I. Note that the transmittance (that is, the optical density of the gradation filter 18) of the pupil in the image PC is not constant and has a gradient along Δξ, but in FIG. 4, the transmittance of the pupil of the condenser lens 15 in the image PC is simply expressed by shading with a constant density. The same applies to FIG. 7, FIG. 15, and FIG. 18 to be described later.

In FIG. 1 to FIG. 3, an example in which each sample S has a constant phase gradient has been described. However, the intensity change of the light beams incident on the imaging element 20 according to the phase gradient of the sample S similarly occurs in one sample. Therefore, in the imaging element 20 of the optical microscope device 1, a gradient contrast image in which the contrast is formed according to the local phase gradient in the sample S is generated.

The gradient contrast image generated by the imaging element 20 is output to the control device 30. In the control device 30, in a case where the processor 31 executes the program stored in the memory 32, the processor 31 measures a phase distribution of the sample S by executing phase distribution measurement processing illustrated in FIG. 6. Specifically, the processor 31 first acquires the gradient contrast image from the imaging element 20 (step S1), then calculates a phase gradient distribution of the sample S based on the acquired gradient contrast image (step S2), and finally calculates a phase distribution of the sample S based on the calculated phase gradient distribution (step S3). Unlike in the differential interference contrast microscope, the gradient contrast image is an image obtained by converting the phase gradient of the sample S into contrast without using polarization characteristics. Therefore, even in a case where there is a birefringent material on the optical path, the phase gradient distribution of the sample S can be calculated from the image information (gradient contrast image), and the phase distribution of the sample S can also be calculated by integrating the calculated phase gradient distribution. Thereby, according to the optical microscope device 1 and the phase distribution measurement processing illustrated in FIG. 6, the phase distribution of the sample S can be measured regardless of the types of the sample S and the sample container.

FIG. 7 is a diagram illustrating a relationship between the position of the image of the pupil of the condenser lens and the transmitted light intensity distribution at the pupil of the objective in a case where the aperture stop is narrowed. FIG. 8 is a graph illustrating a relationship between a movement distance of the image of the pupil of the condenser lens and an image intensity in a case where the aperture stop is narrowed. In a case where the optical density gradient of the gradation filter 18 is constant, a logarithmic value of the image intensity I changes linearly with respect to the position (that is, the pupil movement distance Δξ) of the image PC of the pupil of the condenser lens 15. On the other hand, this relationship is maintained within a range in which the image PC of the pupil of the condenser lens 15 is not vignetted in the pupil PO of the objective 17. For example, as illustrated in FIG. 4, in a case where a diameter of the image PC of the pupil of the condenser lens 15 is approximately a half of the diameter of the pupil PO of the objective 17, the above-described linear relationship is established within a range R1 in which the pupil movement distance Δξ normalized by the diameter of the pupil PO of the objective 17 is approximately −0.5 to 0.5 as illustrated in FIG. 5. In a range in which this linear relationship is established, it is possible to relatively easily calculate the phase gradient distribution of the sample S, and thus, it is desirable that the establishment range of the linear relationship is wide. As illustrated in FIG. 7, narrowing the aperture stop 14 such that a small image PC of the pupil of the condenser lens 15 is projected onto the pupil PO of the objective 17 leads to expansion of the establishment range R2 of the linear relationship as illustrated in FIG. 8. For this reason, it is desirable to narrow the aperture stop 14 within a range in which the resolution is not excessively lowered.

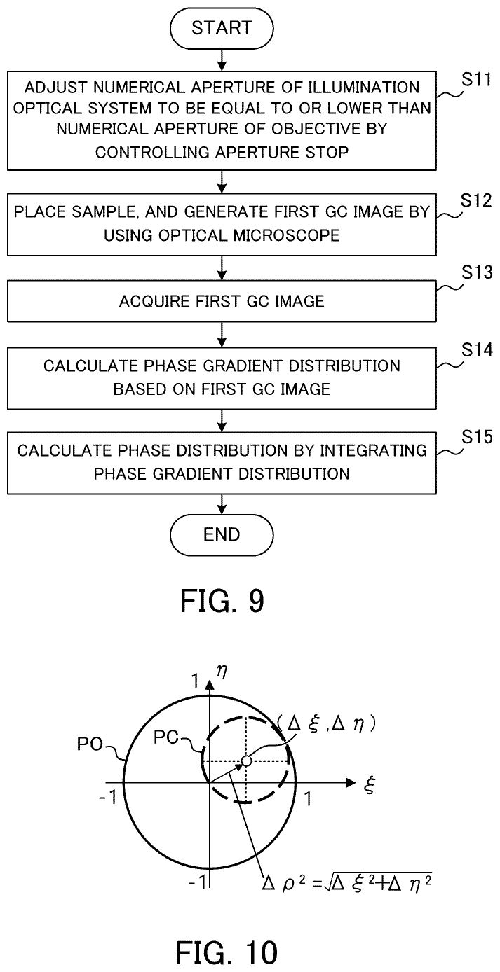

FIG. 9 is a flowchart of processing performed by the optical microscope device according to the present embodiment. Hereinafter, processing performed by the optical microscope device 1 will be described in detail with reference to FIG. 9. Note that the processing performed by the optical microscope device 1 includes the above-described phase distribution measurement processing. In a case where the optical microscope device 1 starts the processing illustrated in FIG. 9, first, the optical microscope device 1 adjusts the numerical aperture of the illumination optical system 12 to be equal to or lower than the numerical aperture of the objective 17 by causing the control device 30 to control the aperture stop 14 (step S11). As a result, as described above, the range in which the linear relationship between the position of the image PC of the pupil of the condenser lens 15 and the logarithmic value of the image intensity I is established is secured. Next, the optical microscope device 1 generates an image in a state where the sample S is placed on the optical microscope 10 (step S12), and acquires the generated image (first gradient contrast image) (step S13). More specifically, the optical microscope 10 and the imaging element 20 generate a first gradient contrast image, and the control device 30 acquires the first gradient contrast image. Thereafter, in the optical microscope device 1, in a case where the first gradient contrast image is acquired, the control device 30 calculates the phase gradient distribution of the sample S based on the first gradient contrast image (step S14). Here, a method of calculating the phase gradient distribution will be described in detail.

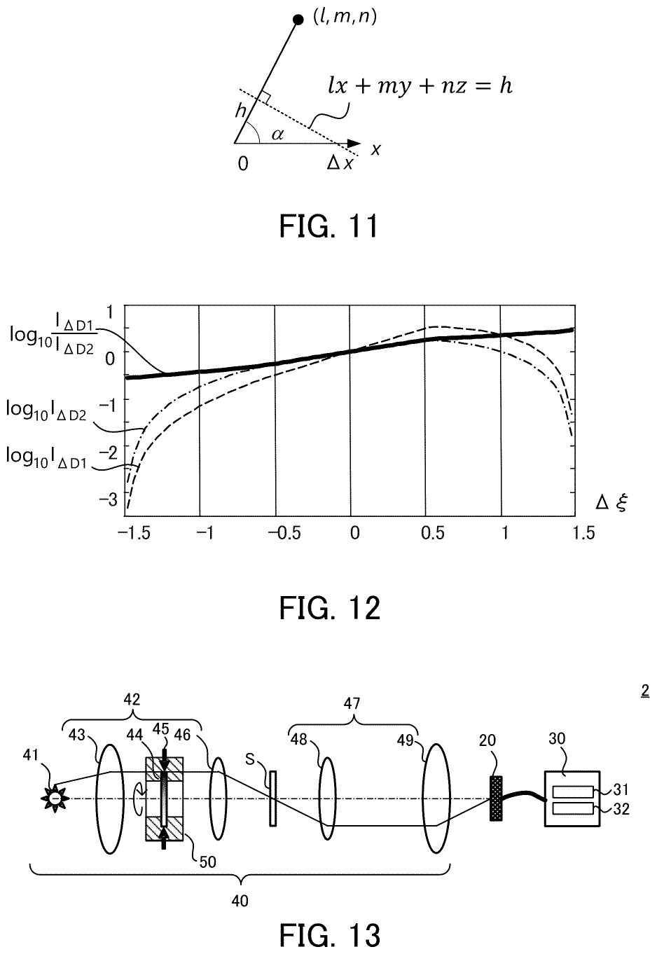

FIG. 10 is a diagram illustrating a center coordinate of an image of a pupil of the condenser lens on a pupil plane of the objective. FIG. 11 is a diagram for explaining a direction cosine of a diffraction wavefront on the sample surface. As illustrated in FIG. 10, a two-dimensional orthogonal coordinate system (ξ, η) in which the origin is at the pupil center of the objective and the pupil radius of the objective is normalized to 1 is taken, and in two axes of the coordinate system, a direction corresponding to the optical density gradient of the gradation filter 18 is defined as a ξ axis, and an axis orthogonal to the ξ axis is defined as an η axis. In addition, the center coordinate of the image PC of the pupil of the condenser lens 15 projected onto the pupil of the objective 17 is defined as (Δξ, Δη). Further, the gradient of the optical density of the gradation filter 18 is defined as ΔD, and the intensity transmittance at ξ=0 of the pupil PO of the objective 17 is defined as T₀. At this time, the intensity transmittance T_{OB} in the pupil PO of the objective 17 and the intensity transmittance T_{CD} in the pupil plane of the condenser lens 15 are expressed by the following Equations.

$${T}_{OB} ( ξ ) = {T}_{0} {10}^{ξ Δ D} \qquad ( 1 )$$

$${T}_{CD} ( ξ , η ; Δ ξ , Δ η ) = 1 ( inside pupil of condenser lens 15 ) \qquad ( 2 )$$

$${T}_{CD} ( ξ , η ; Δ ξ , Δ η ) = 0 ( outside pupil of condenser lens 15 ) \qquad ( 3 )$$

Further, from these relationships, the image intensity I(Δξ, Δη) of the imaging element 20 is expressed as follows. Note that I(0, 0) is the image intensity on the imaging element 20 in a case where the center coordinate of the image PC of the pupil of the condenser lens 15 is (0, 0), that is, at a portion of the sample (sample in a broad sense, entire visual field) without the phase gradient.

$$I ( Δξ , Δη ) = I ( 0 , 0 ) 1 {0}^{Δ ξ Δ D} \qquad ( 4 )$$

From Equation (4), in a case where the optical density gradient ΔD of the gradation filter 18 is known, the center coordinate Δξ of the image PC of the pupil of the condenser lens 15 with respect to the ξ direction corresponding to the optical density gradient of the gradation filter 18 can be calculated from the image intensity I(0, 0) of the portion of the sample (sample in a broad sense is defined as entire visual field) without the phase gradient and the image intensity I(Δξ, Δη) of the portion of the sample with the phase gradient. The image intensity I(0, 0) of the portion of the sample in the broad sense which does not have the phase gradient can be determined based on the image intensity of the region of the first gradient contrast image in which the sample in a narrow sense (that is, the observation target) does not exist. Here, in this example, since the sample in the narrow sense is smaller than the visual field range, the region where the sample does not exist in the visual field can be specified, for example, by being designated by a user. In a case where the sample in the narrow sense is placed so as not to protrude from the visual field, the region where the sample does not exist in the visual field can also be specified by setting the outermost portion in advance as the region where the sample does not exist.

Further, in a case where a direction on the sample surface corresponding to ξ on the pupil plane is defined as an x direction, a numerical aperture of the objective 17 is defined as NA_{ob}, and a refractive index of the sample is defined as n_{medium}, as illustrated in FIG. 11, the direction cosine cosα of the diffracted wave in which the equiphase plane is represented by lx+my+nz=h is expressed by the following Equation.

$$h / Δ x = 1 = cos α = {NA}_{o b} Δξ / {n}_{medium} \qquad ( 5 )$$

In addition, since the phase gradient ∂φ/∂x is a product of the direction cosine cosα and a wave number k, the phase gradient ∂φ/∂x is expressed as follows using Equation (5).

$$\partial φ / \partial x = k cos α = 2 π {NA}_{ob} Δξ / λ \qquad ( 6 )$$

Therefore, in a case where Δξ can be calculated, the phase gradient ∂φ/∂x of the sample S can be calculated using the known numerical aperture NA_{ob} and a wavelength λ from Equation (6).

Finally, in the optical microscope device 1, the control device 30 calculates the phase distribution of the sample S by integrating the phase gradient distribution calculated in step S16 by using definite integration (step S15), and ends the processing illustrated in FIG. 9.

As described above, the optical microscope device 1 can measure the phase distribution of the sample S by performing the processing illustrated in FIG. 9. The optical microscope device 1 is not greatly affected by the presence of the birefringent material unlike the differential interference contrast microscope. Thus, it is possible to measure the phase distribution of the sample regardless of types of the sample and the sample container. In addition, the optical microscope 10 included in the optical microscope device 1 is configured by arranging a gradation filter at a pupil position of an objective of a bright-field microscope adopting Köhler illumination. Therefore, it is possible to measure the phase distribution with a simpler device configuration as compared with a phase measurement device in the related art such as a differential interference contrast microscope. Further, since the optical microscope device 1 does not use interference of light unlike a phase measurement device in the related art such as a differential interference contrast microscope, it is possible to perform phase measurement with higher resolution.

### Second Embodiment

FIG. 12 is a graph illustrating a relationship between a movement distance of an image of the pupil of the condenser lens and a ratio of image intensities of images acquired using gradation filters having different optical density gradients. Note that FIG. 12 illustrates a case where a gradation filter of ΔD₁=1 and a gradation filter of ΔD₂=0.5 are used. In the first embodiment, as described above with reference to FIG. 5 and FIG. 8, a linear relationship between the pupil movement distance Δξ and a logarithmic value of the image intensity I is maintained within a range in which the image PC of the pupil of the condenser lens 15 is not vignetted by the pupil PO of the objective 17. However, as illustrated in FIG. 12, the linear relationship is approximately maintained regardless of the presence or absence of vignetting by using the ratio of the image intensities of two images acquired using gradation filters having different optical density gradients. This is because the effect of light reduction caused by vignetting occurs in both of the two images at the same ratio, and the effect can be canceled out by calculating the ratio of the image intensities. Note that the optical density gradients of the two gradation filters may be, for example, a combination of ΔD₁=1 and ΔD₂=−1 in which absolute values are equal and signs are different. In that case, gradient contrast images for two different optical density gradients can be acquired by rotating one gradation filter by 180°. In the present embodiment, a method of measuring a phase distribution using a ratio of image intensities of two images will be described.

FIG. 13 is a diagram illustrating a configuration of an optical microscope device according to the present embodiment. The optical microscope device 2 illustrated in FIG. 13 includes an optical microscope 40 instead of the optical microscope 10. The optical microscope 40 includes a light source 41, an illumination optical system 42, a detection optical system 47, and a rotation mechanism 50. The illumination optical system 42 includes a collector lens 43, a gradation filter 44 disposed at a position of the aperture stop 45, and a condenser lens 46 in order from the light source side. The detection optical system 47 includes an objective 48 and an imaging lens 49. The optical microscope 40 is different from the optical microscope 10 in that the gradation filter arranged at the pupil of the objective in the optical microscope 10 is arranged at the position of the aperture stop 45 which is a position optically conjugate with the pupil of the objective, and that the rotation mechanism 50 which enables the gradation filter to rotate around the optical axis is further provided. Note that the gradation filter 44 is, for example, an ND filter having characteristics similar to those of the gradation filter 18 according to the first embodiment.

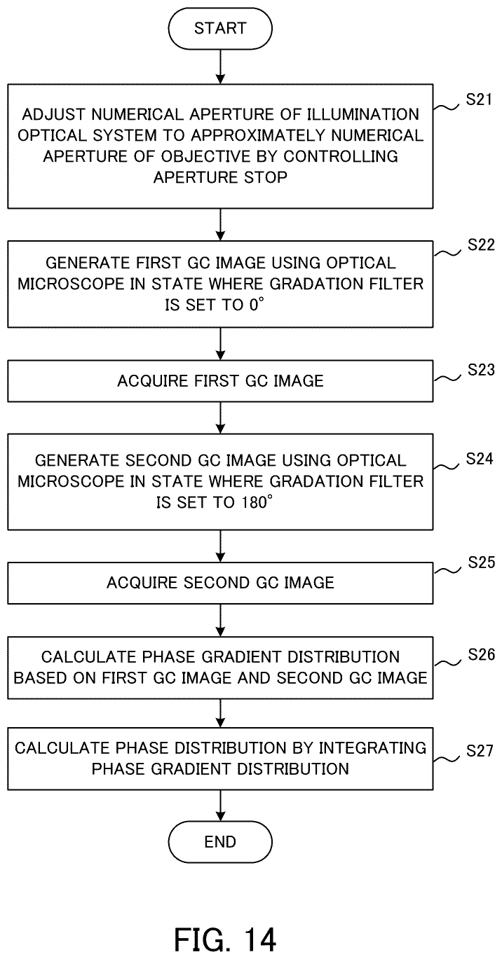

FIG. 14 is a flowchart of processing performed by the optical microscope device according to the present embodiment. Hereinafter, processing performed by the optical microscope device 2 will be described in detail with reference to FIG. 14. Note that the processing performed by the optical microscope device 2 includes phase distribution measurement processing performed by the control device 30. In a case where the optical microscope device 2 starts the processing illustrated in FIG. 14, first, the optical microscope device 2 adjusts the numerical aperture of the illumination optical system 42 to approximately the numerical aperture of the objective 48 by causing the control device 30 to control the aperture stop 45 (step S21). Next, in the optical microscope device 2, the control device 30 sets the gradation filter 44 to 0° with respect to a reference direction (a direction corresponding to the ξ direction) by rotating the gradation filter 44 via the rotation mechanism 50, and generates a first gradient contrast image of the sample S using the optical microscope 40 in a state where the gradation filter 44 is set to 0° (step S22). Thereafter, the control device 30 acquires the generated first gradient contrast image (step S23). Next, in the optical microscope device 2, the control device 30 sets the gradation filter 44 to 180° with respect to a reference direction (a direction corresponding to the ξ direction) by rotating the gradation filter 44 via the rotation mechanism 50, and generates a second gradient contrast image of the sample S using the optical microscope 40 in a state where the gradation filter 44 is set to 180° (step S24). Thereafter, the control device 30 acquires the generated second gradient contrast image (step S25). The step S25 is a step of acquiring the second gradient contrast image of the sample S, the second gradient contrast image being generated in a state where the optical density gradient of the gradation filter 44 disposed at the pupil of the objective or at a position conjugate with the pupil has the same value but the opposite direction as compared with the value and the direction when acquiring the first gradient contrast image. As described above, the optical microscope device 2 generates and acquires two gradient contrast images by reversing the direction of the gradation filter 44. Note that two gradient contrast images generated in a state where the directions of the gradation filter 44 are opposite to each other are hereinafter also referred to as gradient contrast image pairs. In a case where gradient contrast image pairs are acquired, the control device 30 calculates a phase gradient distribution of the sample S based on these images (step S26). Here, a method of calculating the phase gradient distribution will be described in detail.

As described above in the first embodiment, since the image intensity on the imaging element 20 is expressed by Equation (4), the image intensities when the gradation filter 44 is set to 0° and is set to 180° are expressed as follows. Note that the image intensities I_{0°} and I_{180°} are image intensities respectively obtained when the gradation filter 44 is set to 0° and is set to 180°.

$${I}_{0 °} ( Δξ , Δη ) = {I}_{0 °} ( 0 , 0 ) 1 {0}^{Δ ξΔ D} \qquad ( 4 - 1 )$$

$${I}_{180 °} ( Δξ , Δη ) = {I}_{180 °} ( 0 , 0 ) 1 {0}^{- Δ ξΔ D} \qquad ( 4 - 2 )$$

In a case where the gradation filter 44 is rotated around the optical axis, I_{0°}(0, 0) and I_{180°}(0, 0) are equal, and thus, Equation (7) is derived using Equation (4-1) and Equation (4-2). Thereby, Equation (8) is further derived. After Δξ is obtained by Equation (8), the phase gradient ∂φ/∂x can be calculated in the same manner as in the first embodiment.

$${I}_{0 °} ( Δξ , Δη ) / {I}_{180 °} ( Δξ , Δη ) = 1 {0}^{2 Δξ , Δ D} \qquad ( 7 )$$

$$Δξ = ( 1 / ( 2 Δ D ) ) {log}_{10} ( {I}_{0 °} ( Δξ , Δη ) / {I}_{180 °} ( Δξ , Δη ) ) \qquad ( 8 )$$

Finally, in the optical microscope device 2, the control device 30 calculates the phase distribution of the sample S by integrating the phase gradient distribution calculated in step S26 by using definite integration (step S27), and ends the processing illustrated in FIG. 14.

As described above, the optical microscope device 2 can measure the phase distribution of the sample S by performing the processing illustrated in FIG. 14, and can measure the phase distribution of the sample regardless of the types of the sample and the sample container, similarly to the optical microscope device 1. In addition, the optical microscope device 2 is similar to the optical microscope device 1 in that the phase distribution can be measured with a simpler device configuration than the phase measurement device in the related art and that the phase can be measured with higher resolution without using interference of light.

FIG. 15 is a diagram illustrating a relationship among a direction of an optical density gradient of a gradation filter, a position of an image of a pupil of a condenser lens, and a transmitted light intensity distribution in a pupil of an objective. More specifically, FIG. 15 illustrates a state where the gradation filter 44 is inverted as described above and the gradient direction of the optical density is switched between the ξ-plus direction and the ξ-minus direction. FIG. 16 is a graph illustrating a relationship between a movement distance of an image of a pupil of a condenser lens and a ratio of image intensities acquired using gradation filters in which directions of optical density gradients are different. More specifically, FIG. 16 illustrates a relationship of ratios of the image intensities acquired by inverting the gradation filter 44 in a state where the aperture stop is set to approximately the numerical aperture of the objective. In the configuration in which the gradation filter 44 is arranged on the illumination optical path as in the optical microscope device 2, as illustrated in FIG. 16, a peak in the image intensities of the images occurs in the vicinity of Δξ=0. That is, even in a case where the image PC of the pupil is projected in either the ξ-plus direction or the ξ-minus direction, the image intensity decreases. For this reason, the phase distribution is not appropriately expressed by the contrast of brightness and darkness, and the phase distribution is not visualized in the same manner as the differential interference contrast microscope or the like.

However, in the optical microscope device 2, the gradient contrast image is used for phase measurement instead of being directly observed by the user. Therefore, the fact that the gradient contrast image is not necessarily suitable for observation does not particularly hinder phase measurement. Rather, by arranging the gradation filter 44 on the illumination optical path, there is no possibility that movement of the image due to the rotation of the gradation filter 44 occurs, and the phase distribution can be measured with high accuracy. In addition, by performing measurement in a state where the aperture stop is opened to approximately the aperture diameter of the objective, it is possible to avoid a decrease in image resolution in a case where the aperture stop is narrowed. Therefore, according to the optical microscope device 2, the phase distribution can be measured with higher accuracy.

### Third Embodiment

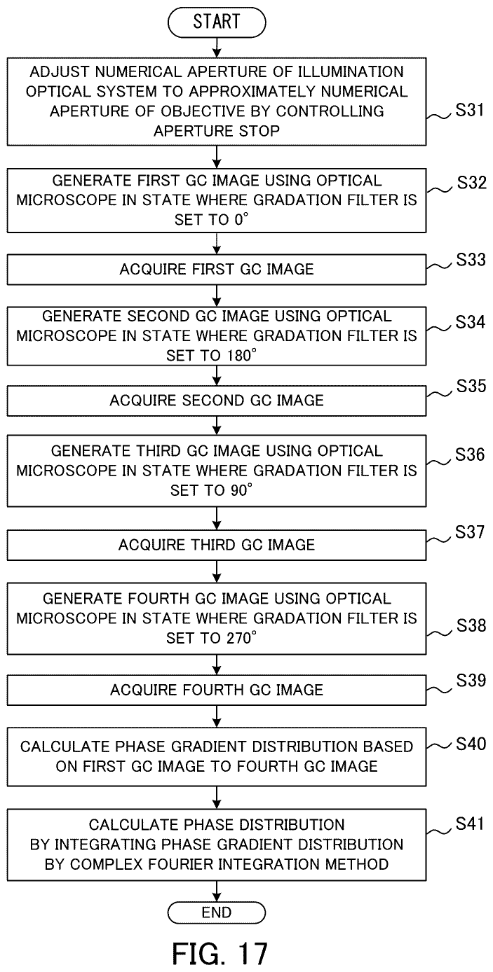

FIG. 17 is a flowchart of processing performed by the optical microscope device according to the present embodiment. The configuration of the optical microscope device according to the present embodiment is similar to, for example, the optical microscope device 2 illustrated in FIG. 13. The optical microscope device according to the present embodiment is different from the optical microscope device 2 in that the processing illustrated in FIG. 17 is performed instead of the processing illustrated in FIG. 14. FIG. 18 is a diagram illustrating a relationship among a direction of an optical density gradient of a gradation filter, a position of an image of a pupil of a condenser lens, and a transmitted light intensity distribution in a pupil of an objective. In the above-described embodiment, an effective example in which the sample S has a phase gradient in one direction (ξ direction) has been described, but in the present embodiment, a two-dimensional phase distribution can be measured in a case where the sample S has a phase gradient in a two-dimensional direction. In a case where the sample S has a phase gradient in a two-dimensional direction, as illustrated in FIG. 18, the position on which the image PC of the pupil of the condenser lens is projected changes not only in the ξ direction but also in a direction (η direction) orthogonal to the ξ direction. Based on this point, hereinafter, processing performed by the optical microscope device according to the present embodiment will be described in detail with reference to FIG. 17. Note that the processing performed by the optical microscope device according to the present embodiment includes phase distribution measurement processing performed by the control device 30.

The optical microscope device according to the present embodiment first adjusts the numerical aperture, and thereafter, generates and acquires the first gradient contrast image and the second gradient contrast image in a state where the gradation filter 44 is set to 0° and is set to 180° (step S31 to step S35). The processing of these steps is similar to the processing of step S21 to step S25 of FIG. 14. Thereafter, the optical microscope device according to the present embodiment further generates and acquires a third gradient contrast image and a fourth gradient contrast image in a state where the gradation filter 44 is set to 90° and is set to 270° (step S36 to step S39). Note that the step S37 is a step of acquiring a third gradient contrast image of the sample, the third gradient contrast image being generated in a state where the direction of the optical density gradient of the gradation filter 44 in the pupil of the objective is orthogonal to the direction when acquiring the first gradient contrast image. In addition, the step S39 is a step of acquiring a fourth gradient contrast image of the sample, the fourth gradient contrast image being generated in a state where the optical density gradient of the gradation filter 44 in the pupil of the objective has the same value but the opposite direction as compared with the value and the direction when acquiring the third gradient contrast image. In a case where the gradient contrast images from the first gradient contrast image to the fourth gradient contrast image are acquired, that is, two sets of gradient contrast image pairs are acquired, the control device 30 calculates the phase gradient distribution of the sample S based on these images (step S40). Here, a method of calculating the phase gradient distribution will be described in detail.

The pupil movement distance Δξ in the ξ direction is calculated by Equation (8) as described above in the third embodiment. Then, the pupil movement distance Δη in the η direction is calculated by the following equation. After Δξ and Δη are obtained by Equation (8) and Equation (9), the phase gradients ∂φ/∂x and ∂φ/∂y can be calculated by the same method as in the first embodiment.

$$Δ η = ( 1 / ( 2 Δ D ) ) {log}_{10} ( {I}_{90 °} ( Δξ , Δη ) / {I}_{270 °} ( Δξ , Δη ) ) \qquad ( 9 )$$

Finally, in the optical microscope device according to the present embodiment, the control device 30 calculates a phase distribution of the sample S by integrating the phase gradient distribution calculated in step S40 by a complex Fourier integration method using the Fourier differential theorem (step S41), and ends the processing illustrated in FIG. 17. The complex Fourier integration method is described in the following document.
Optics Express, Vol. 15, p. 1175 (2007)

In addition, even in a case where the direction of the gradation filter 44 when acquiring the third gradient contrast image and the fourth gradient contrast image is not orthogonal to the direction of the gradation filter 44 when acquiring the first gradient contrast image and the second gradient contrast image, it is easy to apply the complex Fourier integration method by performing conversion into phase gradients in two orthogonal directions using linear algebra.

As described above, the optical microscope device according to the present embodiment can measure the phase distribution of the sample S by performing the processing illustrated in FIG. 17, and can measure the phase distribution of the sample regardless of the types of the sample and the sample container, similarly to the optical microscope device 1 and the optical microscope device 2. In addition, the optical microscope device according to the present embodiment is similar to the optical microscope device 1 and the optical microscope device 2 in that the phase distribution can be measured with a simpler device configuration as compared with the phase measurement device in the related art and that the phase can be measured with higher resolution without using interference of light. In addition, the optical microscope device according to the present embodiment is similar to the optical microscope device 2 in that it is possible to measure the phase distribution with high accuracy by providing the gradation filter 44 on the illumination optical path. Further, the optical microscope device according to the present embodiment can measure a phase distribution of an arbitrary sample without being limited to a sample having a one-dimensional phase gradient by using two sets of gradient contrast image pairs. Furthermore, by using the complex Fourier integration method, the optical microscope device according to the present embodiment can measure a two-dimensional phase distribution that is more resistant to stripe noise and has higher continuity as compared with a case of performing one-dimensional integration in two orthogonal directions.

Note that the order when acquiring the gradient contrast images illustrated in FIG. 17 is not limited thereto. For example, in a case the first gradient contrast image to the fourth gradient contrast image are acquired while the gradation filter is rotated from 0° by 90°, a time required for the rotation of the gradation filter can be further shortened.

### Fourth Embodiment

FIG. 19 is a diagram illustrating a configuration of an optical microscope device according to the present embodiment. The optical microscope device 3 illustrated in FIG. 19 includes an optical microscope 60 instead of the optical microscope 10. The optical microscope 60 is a microscope adopting coaxial epi-illumination, and includes a light source 61, and an illumination optical system 62 and a detection optical system 63 that share some configurations with each other. The illumination optical system 62 includes a collector lens 64, a splitter 65, a gradation filter 66a and a gradation filter 66b having different optical density gradient directions, and an objective 67. In addition, the detection optical system 63 includes the splitter 65, the gradation filter 66a and the gradation filter 66b, the objective 67, and an imaging lens 68. The splitter 65 is, for example, a half mirror. One of the gradation filter 66a and the gradation filter 66b is arranged at a pupil position of the objective 67, that is, a position on the illumination optical path and on the detection optical path. The gradation filter 66a and the gradation filter 66b can be replaced as appropriate.

Similarly to the optical microscope device 2, the optical microscope device 3 performs the processing illustrated in FIG. 14. Here, the processing in step S22 is performed in a state where one of the gradation filter 66a and the gradation filter 66b is inserted on the optical path, and the processing in step S24 is performed in a state where the other of the gradation filter 66a and the gradation filter 66b is inserted on the optical path. Further, in the processing of step S26, Δξ can be calculated by calculation similar to that of the optical microscope device 2. This point will be described.

In the optical microscope device 3, the gradation filters complementarily operate by the illumination light and the detection light, and thus, the intensity transmittance T(Δξ) at the light transmission portion in the pupil plane is constant in the pupil as shown in Equation (10). The image intensity I(Δξ, Δη) on the imaging element 20 is represented by the intensity transmittance T(Δξ) and an area A (Δρ) of the light transmission portion.

$$T ( Δ ξ ) = {T}_{0}^{2} 1 {0}^{ΔξΔ D} \qquad ( 10 )$$

$$A ( Δρ ) = chinesehat ( Δρ / 2 ) \qquad ( 11 )$$

$$I ( Δξ , Δη ) = T ( Δ ξ ) A ( Δρ ) \qquad ( 12 )$$

Here, the chinesehat (Δρ/2) function represents an area of a portion where two circles having a radius of 1 overlap each other at a distance of the center distance Δρ.

In a case where the optical densities of the gradation filter 66a and the gradation filter 66b are inverted by 180°, the image intensities I_{0°}(Δξ, Δη) and I_{180°}(Δξ, Δη) of the gradient contrast images acquired using the respective filters and a ratio of the image intensities are expressed by the following equations.

$${I}_{0 °} ( Δξ , Δη ) = {I}_{0 °} ( 0 , 0 ) T ( Δ ξ ) A ( Δρ ) \qquad ( 13 )$$

$${I}_{180 °} ( Δξ , Δη ) = {I}_{180 °} ( 0 , 0 ) T ( - Δξ ) A ( Δρ ) \qquad ( 14 )$$

$${I}_{0 °} ( Δξ , Δη ) / {I}_{180 °} ( Δξ , Δη ) = {I}_{0 °} ( 0 , 0 ) / {I}_{180 °} ( 0 , 0 ) 1 {0}^{2 ΔξΔ D} \qquad ( 15 )$$

Therefore, Δξ can be calculated by Equation (8) as in the second embodiment. As described above, the optical microscope device 3 can measure the phase distribution of the sample S by the same method as in the above-described embodiment, and can measure the phase distribution of the sample regardless of the types of the sample and the sample container, similarly to the optical microscope device 1 and the optical microscope device 2. In addition, the optical microscope device according to the present embodiment is similar to the optical microscope device 1 and the optical microscope device 2 in that the phase distribution can be measured with a simpler device configuration as compared with the phase measurement device in the related art and that the phase can be measured with higher resolution without using interference of light. In addition, in the optical microscope device 3, since the gradation filters complementarily operate by both the illumination light and the detection light, the pupil transmission intensity distribution becomes uniform, and a deviation in a defocus image can be prevented. Furthermore, as in the optical microscope device according to the third embodiment, it is possible to measure the two-dimensional phase distribution of the sample by acquiring two sets of image pairs.

### Fifth Embodiment

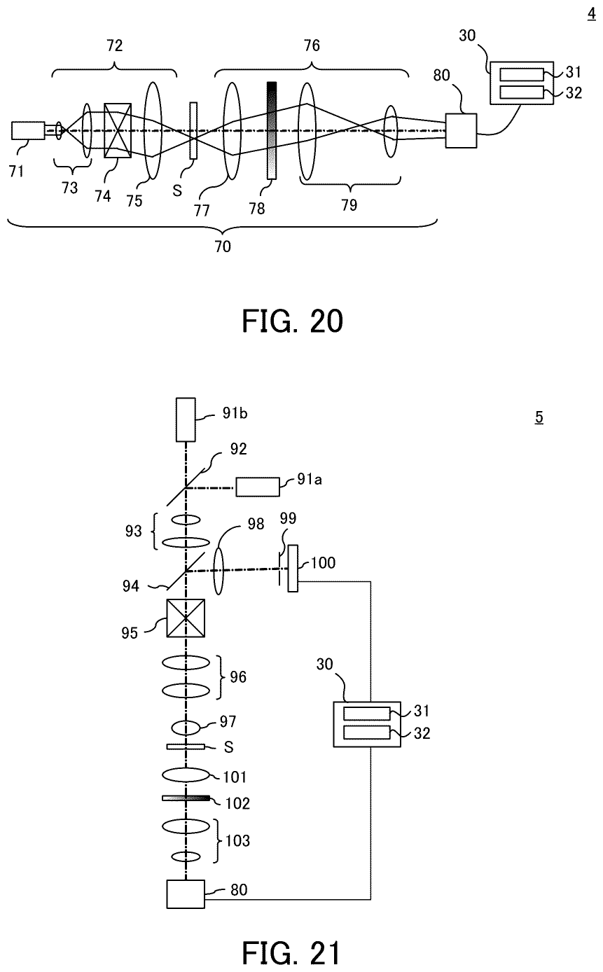

FIG. 20 is a diagram illustrating a configuration of an optical microscope device according to the present embodiment. The optical microscope device 4 illustrated in FIG. 20 includes an optical microscope 70 instead of the optical microscope 10 and a light detector 80 instead of the imaging element 20. The optical microscope device 4 is a transmission detection type laser scanning microscope device that scans the sample S with a laser beam to form a two-dimensional image of the sample S. The optical microscope device 4 is similar to the optical microscope device 1 to the optical microscope device 3 described above in that the gradation filter 78 is provided at a position conjugate with the pupil of the objective 75 and the phase gradient is converted into the image intensity by the modulation in the gradation filter 78. More specifically, the optical microscope 70 includes a laser light source 71, an illumination optical system 72, and a detection optical system 76. The illumination optical system 72 includes a beam expander 73, a galvano mirror 74, and an objective 75. The detection optical system 76 includes a condenser lens 77, a gradation filter 78, and a focusing lens 79.

Since the optical microscope device 4, which is a laser scanning microscope device, can also acquire a gradient contrast image similarly to the optical microscope device according to the above-described embodiment, it is possible to measure the phase distribution of the sample S based on the gradient contrast image by performing similar processing.

### Sixth Embodiment

FIG. 21 is a diagram illustrating a configuration of an optical microscope device according to the present embodiment. The optical microscope device 5 illustrated in FIG. 21 is obtained by applying the above-described optical microscope device 4 to an epi-fluorescence detection type laser scanning microscope. More specifically, the optical microscope device 5 includes a laser light source 91a, a laser light source 91b, a dichroic mirror 92, a beam expander 93, a dichroic mirror 94, a galvano mirror 95, a pupil relay lens 96, an objective 97, a focusing lens 98, a pinhole plate 99, a PMT 100, a condenser lens 101, a gradation filter 102, a focusing lens 103, a light detector 80, and a control device 30. The optical microscope device 5 can measure the phase distribution of the sample S with a transmission detection configuration similar to that of the optical microscope device 4 and align the sample S, before acquiring a fluorescence image. Therefore, it is possible to suppress fading of the sample S before a fluorescence image is acquired.

The embodiments described above are illustrative examples shown to facilitate understanding of the invention. The present invention is not limited to the above-described embodiments, and should be understood as including various modifications and alternative forms of the above-described embodiments.

In the fourth embodiment described above, the optical microscope device in which the gradation filter is disposed at the position on the illumination optical path and the detection optical path has been exemplified. On the other hand, in the transmission detection type optical microscope device, respective gradation filters (a first gradation filter and a second gradation filter) may be disposed on each of the illumination optical path and the detection optical path. In this case, the first gradation filter and the second gradation filter may be disposed at the pupil of the objective or at a position optically conjugate with the pupil. Note that the second gradation filter is a filter having an optical density gradient that monotonically increases or monotonically decreases in a direction opposite to the first gradation filter and that is constant in a direction orthogonal to the direction in which the gradient monotonically increases or monotonically decreases. Further, the first gradation filter and the second gradation filter may be arranged such that the optical microscope projects a region of the first gradation filter having a higher optical density onto a region of the second gradation filter having a lower optical density in a case where there is no phase gradient in the sample. Thereby, the first gradation filter and the second gradation filter complementarily operate, and thus, it is possible to obtain an effect similar to that of the optical microscope device 3 illustrated in FIG. 19.

Further, in the above-described embodiment, the example of measuring the phase distribution of the sample has been described, but the intensity transmittance distribution of the sample may be further measured. For example, the processor 31 of the control device 30 may further perform processing of calculating, based on the phase distribution calculated by the above-described processing, an image intensity distribution of a gradient contrast image of a pure phase object having the phase distribution. The processor 31 may further execute processing of calculating the intensity transmittance distribution of the sample based on a comparison between the image intensity distribution of the gradient contrast image of the sample, which is the gradient contrast image acquired using the optical microscope and for which the phase distribution is measured, and the image intensity distribution of the gradient contrast image of the pure phase object, which is calculated by calculation using the above-described processing. Thereby, the intensity transmittance distribution of the sample can be measured without being affected by the image intensity distribution caused by the phase distribution of the sample. This point will be described.

In a case where the sample has the intensity transmittance distribution, that is, in a case where the sample is not a pure phase object, the image intensity is expressed by the following equation. Here, I₀(x, y) is an image intensity distribution in a case where the phase distribution is removed from the sample.

$${I}_{0 °} ( x , y ) = {I}_{0} ( x , y ) T ( Δ ξ ( x , y ) ) A ( Δρ ( x , y ) ) \qquad ( 16 )$$

$${I}_{180 °} ( x , y ) = {I}_{0} ( x , y ) T ( - Δξ ( x , y ) ) A ( Δρ ( x , y ) ) \qquad ( 17 )$$

Even in this case, since the following equation is derived, the phase distribution of the sample can be calculated independently regardless of the intensity transmittance distribution of the sample.

$${I}_{0 °} ( x , y ) / {I}_{180 °} ( x , y ) = T ( Δ ξ ( x , y ) ) / T ( - Δ ξ ( x , y ) ) = {10}^{2 Δ D Δ ξ ( x , y )} \qquad ( 18 )$$

On the other hand, the geometric mean of the image intensities of the image pairs is a bright-field image that is affected by both the intensity transmittance distribution and the phase distribution of the sample, as shown in the following equation.

$$SQRT ( {I}_{0 °} ( x , y ) {I}_{180 °} ( x , y ) ) = {I}_{0 °} ( x , y ) A ( Δρ ( x , y ) ) \qquad ( 19 )$$

The image intensity distribution I_{0°}′(x, y) of the gradient contrast image in a case where the intensity transmittance distribution of the sample is removed to form a virtual pure phase object is expressed by the following equation using a constant I₀′.

$${I}_{{0}^{∘}}^{′} ( x , y ) = {I}_{0}^{′} T ( Δ ξ ( x , y ) ) A ( Δρ ( x , y ) ) \qquad ( 20 )$$

The intensity transmittance distribution of the sample is calculated by a ratio between the image intensity distribution of the gradient contrast image of the sample and the image intensity distribution of the gradient contrast image of the virtual pure phase object.

$${I}_{0 °} ( x , y ) / {I}_{{0}^{∘}}^{′} ( x , y ) = {I}_{0} ( x , y ) / {I}_{0}^{′} \qquad ( 21 )$$

What is claimed is:

1. A phase distribution measurement method comprising:
acquiring a gradient contrast image that is a digital image of a sample generated based on an intensity of light beams detected by a light detection element via a first gradation filter disposed at a pupil of an objective in an optical microscope or at a position optically conjugate with the pupil;
calculating a phase gradient distribution of the sample based on the gradient contrast image; and
calculating a phase distribution of the sample based on the phase gradient distribution,
wherein the first gradation filter has an optical density gradient that monotonically increases or monotonically decreases in a predetermined direction and that is constant in a direction orthogonal to the predetermined direction.

2. The phase distribution measurement method according to claim 1, wherein
acquiring the gradient contrast image includes:
acquiring a first gradient contrast image of the sample, and
acquiring a second gradient contrast image of the sample, the second gradient contrast image being generated in a state where an optical density gradient of the first gradation filter in the pupil has a value different from a value when acquiring the first gradient contrast image.

3. The phase distribution measurement method according to claim 1, wherein
acquiring the gradient contrast image includes:
acquiring a first gradient contrast image of the sample, and
acquiring a third gradient contrast image of the sample, the third gradient contrast image being generated in a state where an optical density gradient of the first gradation filter in the pupil is in a predetermined direction different from a direction when acquiring the first gradient contrast image.

4. The phase distribution measurement method according to claim 2, wherein
acquiring the gradient contrast image further includes:
acquiring a third gradient contrast image of the sample, the third gradient contrast image being generated in a state where an optical density gradient of the first gradation filter in the pupil is in a predetermined direction different from a direction when acquiring the first gradient contrast image, and
acquiring a fourth gradient contrast image of the sample, the fourth gradient contrast image being generated in a state where an optical density gradient of the first gradation filter in the pupil has a value different from a value when acquiring the third gradient contrast image.

5. The phase distribution measurement method according to claim 3, wherein
calculating the phase distribution includes calculating the phase distribution using a complex Fourier integration method.

6. The phase distribution measurement method according to claim 1, wherein
the gradient contrast image is generated based on an intensity of light beams detected by the light detection element via the first gradation filter and a second gradation filter disposed at the pupil or at a position optically conjugate with the pupil, the second gradation filter having an optical density gradient which monotonously increases or monotonously decreases in a direction opposite to the first gradation filter and that is constant in a direction orthogonal to the direction in which the gradient monotonously increases or monotonously decreases,
one of the first gradation filter and the second gradation filter is disposed on an illumination optical path of the optical microscope,
the other of the first gradation filter and the second gradation filter is disposed on a detection optical path of the optical microscope, and
in a case where there is no phase gradient in the sample, the optical microscope projects a region of the first gradation filter having a higher optical density onto a region of the second gradation filter having a lower optical density.

7. The phase distribution measurement method according to claim 1, wherein
the first gradation filter is arranged on an illumination optical path of the optical microscope and on a detection optical path of the optical microscope.

8. The phase distribution measurement method according to claim 1, further comprising:
calculating an image intensity distribution of a gradient contrast image of a pure phase object having the phase distribution; and
calculating an intensity transmittance distribution of the sample based on a comparison between the image intensity distribution of the gradient contrast image of the sample and the image intensity distribution of the gradient contrast image of the pure phase object.

9. The phase distribution measurement method according to claim 1, wherein
the gradient contrast image is an image generated in a state where a numerical aperture of an illumination optical system of the optical microscope is equal to or smaller than a numerical aperture of the objective.

10. An optical microscope device comprising:
an optical microscope including an objective and a first gradation filter disposed at a pupil of the objective or at a position optically conjugate with the pupil, the first gradation filter having an optical density gradient that monotonously increases or monotonously decreases in a predetermined direction and that is constant in a direction orthogonal to the predetermined direction;
a light detection element that is configured to detect light beams passing through the objective and the first gradation filter; and
a processor that is configured to execute: processing of acquiring a gradient contrast image which is a digital image of a sample generated based on an intensity of light beams detected by the light detection element; processing of calculating a phase gradient distribution of the sample based on the acquired gradient contrast image; and processing of calculating a phase distribution of the sample based on the phase gradient distribution.

11. The optical microscope device according to claim 10, wherein
the processing of acquiring the gradient contrast image by the processor includes:
processing of acquiring a first gradient contrast image of the sample, and
processing of acquiring a second gradient contrast image of the sample, the second gradient contrast image being generated in a state where an optical density gradient of the first gradation filter in the pupil has a value different from a value when acquiring the first gradient contrast image.

12. The optical microscope device according to claim 10, wherein
the processing of acquiring the gradient contrast image by the processor includes:
processing of acquiring a first gradient contrast image of the sample, and
processing of acquiring a second gradient contrast image of the sample, the second gradient contrast image being generated in a state where an optical density gradient of the first gradation filter in the pupil is in a predetermined direction different from a direction when acquiring the first gradient contrast image.

13. The optical microscope device according to claim 11, wherein
the processing of acquiring the gradient contrast image by the processor further includes:
acquiring a third gradient contrast image of the sample, the third gradient contrast image being generated in a state where an optical density gradient of the first gradation filter in the pupil is in a predetermined direction different from a direction when acquiring the first gradient contrast image, and
acquiring a fourth gradient contrast image of the sample, the fourth gradient contrast image being generated in a state where an optical density gradient of the first gradation filter in the pupil has a value different from a value when acquiring the third gradient contrast image.

14. The optical microscope device according to claim 12, wherein
the processing of calculating the phase distribution includes processing of calculating the phase distribution using a complex Fourier integration method.

15. The optical microscope device according to claim 10, wherein
the optical microscope further includes a second gradation filter disposed at the pupil or at a position optically conjugate with the pupil, the second gradation filter having an optical density gradient which monotonously increases or monotonously decreases in a direction opposite to the first gradation filter and that is constant in a direction orthogonal to the direction in which the gradient monotonously increases or monotonously decreases,
the gradient contrast image is generated based on an intensity of light beams detected by the light detection element via the first gradation filter and the second gradation filter,
one of the first gradation filter and the second gradation filter is disposed on an illumination optical path of the optical microscope,
the other of the first gradation filter and the second gradation filter is disposed on a detection optical path of the optical microscope, and
in a case where there is no phase gradient in the sample, the optical microscope projects a region of the first gradation filter having a higher optical density onto a region of the second gradation filter having a lower optical density.

16. The optical microscope device according to claim 10, wherein
the first gradation filter is arranged on an illumination optical path of the optical microscope and on a detection optical path of the optical microscope.

17. The optical microscope device according to claim 10, wherein
the processor is configured to further execute:
processing of calculating an image intensity distribution of a gradient contrast image of a pure phase object having the phase distribution, and
processing of calculating an intensity transmittance distribution of the sample based on a comparison between the image intensity distribution of the gradient contrast image of the sample and the image intensity distribution of the gradient contrast image of the pure phase object.

18. The optical microscope device according to claim 10, wherein
the optical microscope further includes an aperture stop that adjusts a numerical aperture of an illumination optical system of the optical microscope.

19. The optical microscope device according to claim 18, wherein
the processor is configured to control the aperture stop such that a numerical aperture of the illumination optical system is equal to or smaller than a numerical aperture of the objective.
